(19) United States
(12) Patent Application Publication
(10) Pub. No.: US 2014/0320952 A1
(43) Pub. Date: Oct. 30, 2014

(54) Head-Up Display Device

(71) Applicant: NATIONAL TSING HUA UNIVERSITY, Hsinchu (TW)

(72) Inventor: Cheng-Huan Chen, Hsinchu (TW)

(73) Assignee: National Tsing Hua University, Hsinchu (TW)

(21) Appl. No.: 13/871,090

(22) Filed: Apr. 26, 2013

(51) Int. Cl. G02B 27/01; G02F 1/29

(52) U.S. Cl. CPC G02B 27/0101; G02F 1/29
USPC 359/303; 359/489.01; 359/298

(57) ABSTRACT

A head-up display device operated in a vehicle comprises: a first image source disposed under the windshield of the vehicle, which emits a first polarized image light having a first polarization; a light path combining component in front of the first image source, which is for that the first polarized image light firstly goes to the light path combining component and only lets the first polarized image light be through and then the image light goes to the windshield, part of the image light is reflected by the windshield to a driver's eyes; and a second image source inside the vehicle, which emits a second polarized image light having a second polarization and then the image light directly goes to or reflects at least one time to the combining component, continuously to the windshield, and the second polarized image light is partially reflected by the windshield to the eyes.

### BACKGROUND OF THE INVENTION

1. Field of the Invention

The present invention generally relates to a head-up display device, more particularly to a head-up display device that is capable of displaying a long-distance image and a short-distance image simultaneously or one of the long-distance image and short-distance image on the eyes of a driver through polarized technologies or a general shading/non-shading device.

2. Description of the Prior Art

Vehicle driving on the road is constantly changing. Example, vehicle facing a straight road in a countryside or flooded with a variety of vehicles on a road in a city, the situation is also very different. Furthermore, because of the different time of a day, such as in the morning, evening or night, the line of sight may be different, driver will face a different way to drive. More specifically, if vehicle fast traveling on a straight road in a countryside in the evening, the line of sight is not very good as always, but speed should not be too slow. At this point, if a sudden object appears in front of the vehicle, the driver must first feel the front object, and then must be aware of what kind of object is in order to carry out the necessary contingency. For example, if there is an animal, what kind of animal is should be the first priority, and then its volume must know as soon as the first priority is assured, continuously an emergency measure can be made. However, such detection and confirmation device, in order to increase the safety of driving, is still not found in the field.

With reference to FIG. 6, which illustrates a representative view of a head-up display device of a patent, issue No. M332601, of Republic of China. As shown in figure, the head-up display device is applied in a vehicle that has at least one signal generating device 2A for providing at least one signal source. The head-up display device 1A has: an HMI (Human Machine Interface) 19A, which electrically connects with the signal generating device 2A for selecting the signal source; an interface circuit 11A, which receives the signal source selected by the HMI 19A and transforms the signal source to an image signal; an imaging surface 17A, which essentially forms on the windshield of the vehicle; and a projecting unit 15A, which receives the imaging signal from the interface circuit 11A and transforms the imaging signals to a screen that is projected to the imaging surface 17A, wherein the projecting unit 15A further has a lens, a DMD (Digital Micromirror Device) and a camera lens (not shown in figure), the image signal is projected to the DMD through the lens, so that the screen is formed on the DMD, and thus the screen is projected to the imaging surface 17A through the camera lens. Since the DMD receives digital signals and projects the screen via the way of digital pulse, hence its resolution is higher and facilitates to projected screens with small dimensions. As it can be seen, the applications and features of the prior art are different than the present invention's.

With reference to FIG. 7, which illustrates a representative view of a head-up display apparatus of a patent, issue No. U.S. Pat. No. 7,936,518B2, of USA. The head-up display apparatus includes an infrared ray emitting unit 5B for emitting an infrared ray toward a user D, a mirror member 3B for reflecting visible light L emitted from a display 2B toward a combiner member 4B, and transmitting the infrared ray reflected by the user D and the combiner member 4B, a plurality of imaging units 6B and 7B disposed to face the mirror member 3B for sensing the infrared ray, each imaging the user from differing directions, and an image processing unit 8B for calculating the eye position of the user based on an image captured by the imaging units 6B and 7B. Hence, talking about functions, the patent of U.S. Pat. No. 8,035,879B2 adopts that the infrared ray and visible light are projected to the windshield and further reflected to the eye of the user, thus the image processing unit is able to capture the status and position of the eye. As a conclusion, the prior art is to capture the position of the eye so as to avoid the driver dozes while in driving. So the applications and features of the prior art are different than the present invention's.

Nowadays, there is no head-up display device that is able to display two images simultaneously for displaying outer conditions based on different demands while a vehicle in driving in order to warn a driver to have some emergency measures yet. Therefore, how to design such head-up display device will be an important issue for the skilled in the art.

### SUMMARY OF THE INVENTION

The main objective of the present invention is to provide a head-up display device, which is able to display a long-distance mode and a short-distance mode simultaneously for specific display or warning purposes.

The other objective of the present invention is to provide the head-up display device, which can choose one of the long-distance mode or the short-distance mode based on demands. While to monitor both the images of the long-distance mode and the short-distance mode is not a must, the function of only one mode being activated is ready for the present invention.

To reach above objectives, a head-up display device that is operated in a vehicle comprises: a first image source, which is disposed under the windshield of the vehicle, the first image source emits a first polarized image light having a first polarization; a light path combining component, which is in front of the first image source for that the first polarized image light firstly goes to the light path combining component after the first polarized image light is emitted by the first image source, the light path combining component only lets the first polarized image light be through, the first polarized image light P then goes to the windshield, thus part of the first polarized image light is reflected by the windshield to the eyes of a driver; and a second image source, which is inside the vehicle, the second image source emits a second polarized image light having a second polarization, the second polarized image light directly goes to or reflects at least one time to the light path combining component, the light path combining component thus reflects the second polarized image light to the windshield, and the second polarized image light is partially reflected by the windshield to the eyes of the driver, with the first polarized image light goes to the eyes of the driver, a second light path of the second image source to the eyes of the driver is longer than a first light path of the first image source to the eyes of the driver since the second polarized image light travels longer distance before hitting on the windshield.

To reach above objectives, a head-up display device that is operated in a vehicle comprises: a first image source, which is disposed under the windshield of the vehicle, the first image source emits a first polarized image light having a first polarization; a light path combining component, which has a penetration mode and a mirror mode and is in front of the first image source for that the first polarized image light firstly goes to the light path combining component after the first polarized image light is emitted by the first image source, while the light path combining component is under the penetration mode, the light path combining component only lets the first polarized image light be through, the first polarized image light P then goes to the windshield, thus part of the first polarized image light is reflected by the windshield to the eyes of a driver, the driver being only able to see a first virtual image of the first image source formed on the windshield; and a second image source, which is inside the vehicle, the second image source emits a second polarized image light having a second polarization, the second polarized image light directly goes to or reflects at least one time to the light path combining component, while the light path combining component (12′) is under the mirror mode, the light path combining component thus reflects the second polarized image light to the windshield, and the second polarized image light is partially reflected by the windshield to the eyes of the driver, a second light path of the second image source to the eyes of the driver is longer than a first light path of the first image source to the eyes of the driver since the second polarized image light travels longer distance before hitting on the windshield, so that the driver feels that the first virtual image of the first polarized image light is closer than a second virtual image of the second polarized image light.

To reach above objectives, a head-up display device that is operated in a vehicle comprises: a first movable image source, which is disposed under the windshield of the vehicle, the first movable image source emits a first image light; a shading/non-shading device, which has functions of shading light and lets light be through and is in front of the first movable image source for that the first image light firstly goes to the shading/non-shading device after the first image light is emitted by the first movable image source, while the shading/non-shading device is under the function of letting light be through, the shading/non-shading device only lets the first image light be through, the first image light then goes to the windshield, thus part of the first image light is reflected by the windshield to the eyes of a driver, the driver is only able to see a first virtual image of the first movable image source formed on the windshield; and a second movable image source, which is inside the vehicle, the second movable image source emits a second image light, the second image light directly goes to or reflects at least one time to the shading/non-shading device after the second image light is emitted by the second movable image source, while the shading/non-shading device is under the function of shading light, the shading/non-shading device thus reflects the second image light to the windshield, and the second image light is partially reflected by the windshield to the eyes of the driver, a second light path of the second movable image source to the eyes of the driver is longer than a first light path of the first movable image source to the eyes of the driver since the second image light travels longer distance before hitting on the windshield, so that the driver feels that the first virtual image of the first image light is closer than a second virtual image of the second image light.

Other and further features, advantages, and benefits of the invention will become apparent in the following description taken in conjunction with the following drawings. It is to be understood that the foregoing general description and following detailed description are exemplary and explanatory but are not to be restrictive of the invention. The accompanying drawings are incorporated in and constitute a part of this application and, together with the description, serve to explain the principles of the invention in general terms. Like numerals refer to like parts throughout the disclosure.

### BRIEF DESCRIPTION OF THE DRAWINGS

The objects, spirits, and advantages of the preferred embodiments of the present invention will be readily understood by the accompanying drawings and detailed descriptions, wherein:

FIG. 1 illustrates a schematic view of a first preferred embodiment of the head-up display device of the present invention;

FIG. 2 illustrates a schematic view of a first part of a second preferred embodiment of the head-up display device of the present invention;

FIG. 3 illustrates a schematic view of a second part of the second preferred embodiment of the present invention;

FIG. 4 illustrates a schematic view of a first part of a third preferred embodiment of the present invention;

FIG. 5 illustrates a schematic view of a second part of the third preferred embodiment of the present invention;

FIG. 6 illustrates a representative view of a head-up display device of a patent, issue No. M332601, of Republic of China; and

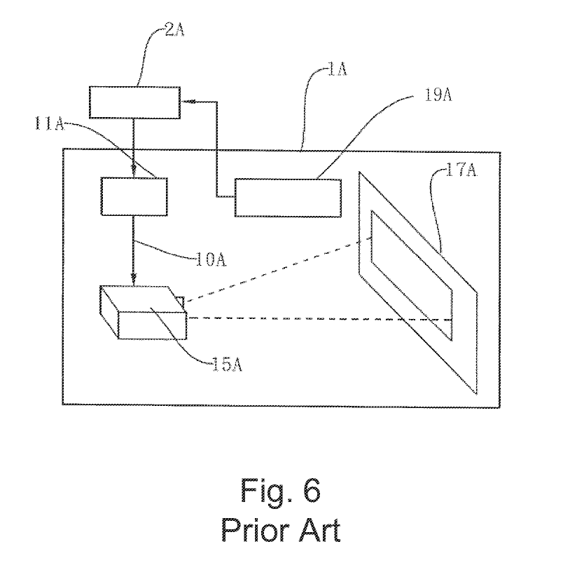

FIG. 7 illustrates a representative view of a head-up display apparatus of a patent, issue No. U.S. Pat. No. 7,936,518B2, of USA.

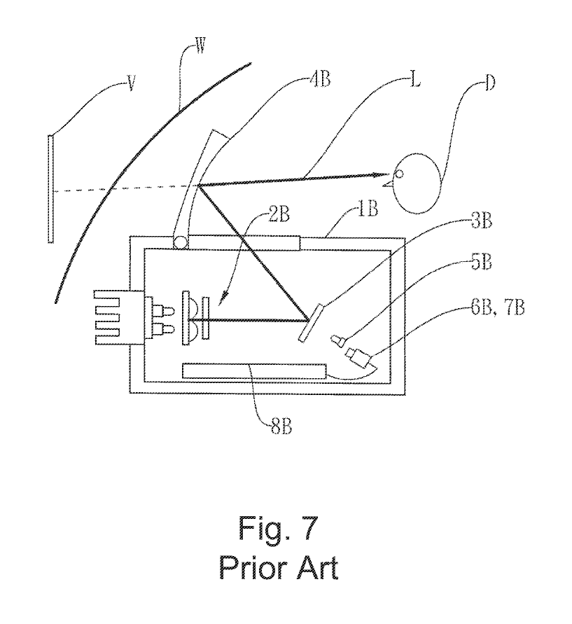

### DETAILED DESCRIPTION OF THE INVENTION

Following preferred embodiments and figures will be described in detail so as to achieve aforesaid objects.

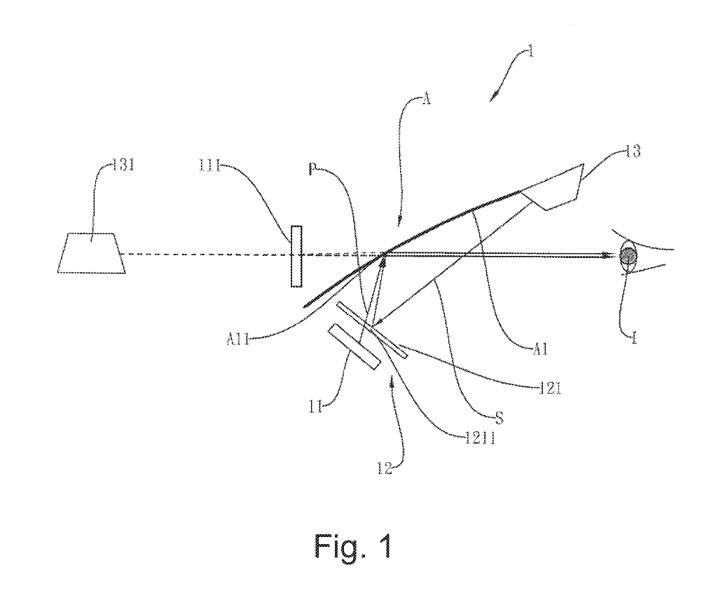

With reference to FIG. 1, which illustrates a schematic view of a first preferred embodiment of the head-up display device of the present invention. As shown in figure, the head-up display device 1 that is operated in a vehicle includes: a first image source 11, which is disposed under the windshield A of the vehicle, the first image source 11 emits a first polarized image light P having a first polarization p, the polarization of the first polarization p of the first polarized image light P is right hand circular polarization or P-state linear polarization; a light path combining component 12, which is in front of the first image source 11 for that the first polarized image light P firstly goes to the light path combining component 12 after the first polarized image light P is emitted by the first image source 11, the light path combining component 12 is a reflective polarizer plate, the light path combining component 12 only lets the first polarized image light P be through, the first polarized image light P then goes to the windshield A, and after the first polarized image light P arrives at the point A11 of the inner surface Al of the windshield A, thus part of the first polarized image light P is reflected by the windshield A to the eyes I of a driver; and a second image source 13, which is inside the vehicle and is disposed at the top of the windshield A, the second image source 13 emits a second polarized image light S having a second polarization s, the polarization of the second polarization s of the second polarized image light S is left hand circular polarization or S-state linear polarization, the second polarized image light S directly goes to or reflects at least one time to the point 1211 of the outer surface 121 of the light path combining component 12 after the second polarized image light S is emitted by the second image source 13, the light path combining component 12 thus reflects the second polarized image light S to the point A11 of the inner surface A1 of the windshield A, and the second polarized image light S is partially reflected by the windshield A to the eyes I of the driver, therefore, with the first polarized image light P going to the eyes I of the driver, the driver may see two images, and the path between the point A11 and the eyes I is a light-combining path, that is, the light-combining path is the overlapped part of the first polarized image light P and the second polarized image light S, however, a second light path of the second image source 13 to the eyes I of the driver is longer than a first light path of the first image source 11 to the eyes of the driver since the second polarized image light S travels longer distance before hitting on the windshield (A), so that the driver feels that the first virtual image 111 of the first polarized image light P is closer than a second virtual image 131 of the second polarized image light S, and because of the windshield A being transparent, there are two images shown, the first virtual image 111 and the second virtual image 131, under partial reflection.

As a matter of fact, the polarization of the first polarization of the first polarization image light is orthogonal to the polarization of the second polarization of the second polarization image light. Hence, for the first preferred embodiment, a first pattern for the polarizations of the first polarization p of the first polarized image light P and the second polarization s of the second polarized image light S being P-state linear polarization and S-state linear polarization is disclosed, and a second pattern for the polarizations of the first polarization p of the first polarized image light P and the second polarization s of the second polarized image light S being S-state linear polarization and P-state linear polarization is disclosed.

In addition, as aforesaid a third pattern for the first preferred embodiment, while the polarization of the first polarization p of the first polarized image light P is right hand circular polarization and the polarization of the second polarization s of the second polarized image light S is left hand circular polarization; on the other hand, a fourth pattern for the first preferred embodiment is disclosed, the polarization of the first polarization p of the first polarized image light P is left hand circular polarization and the polarization of the second polarization of the second polarized image light is right hand circular polarization.

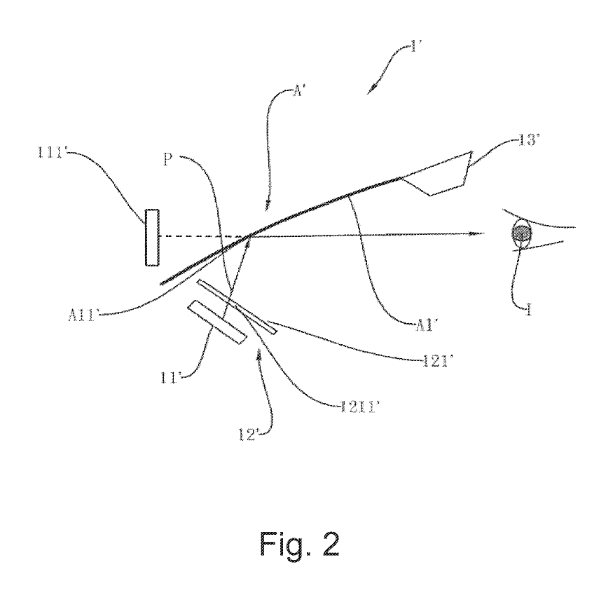

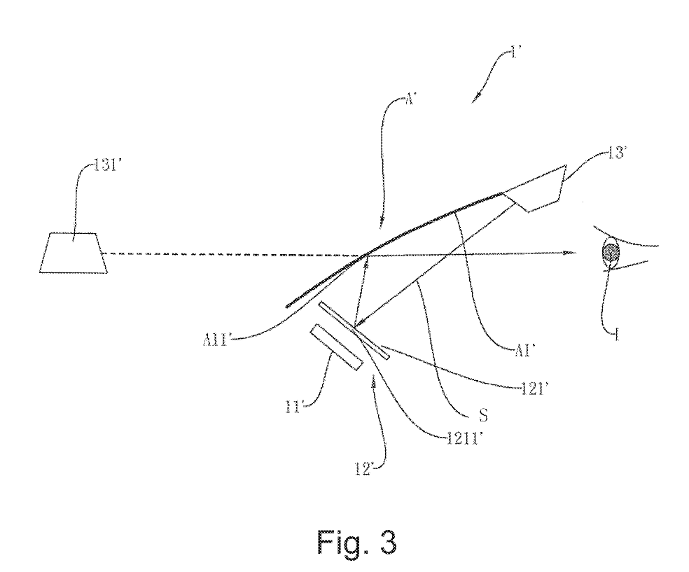

With reference to FIG. 2, which illustrates a schematic view of a first part of a second preferred embodiment of the head-up display device of the present invention. As shown in figure, the head-up display device 1′ that is operated in a vehicle includes: a first image source 11′, which is disposed under the windshield A′ of the vehicle, the first image source 11′ emits a first polarized image light P having a first polarization p, the polarization of the first polarization p of the first polarized image light P is right hand circular polarization; a light path combining component 12′, which has a penetration mode and a mirror mode and is in front of the first image source 11′ for that the first polarized image light P firstly goes to the light path combining component 12′ after the first polarized image light P is emitted by the first image source 11′, the light path combining component 12′ is a switch mirror reflecting component, while the light path combining component 12′ is under the penetration mode, the light path combining component 12′ only lets the first polarized image light P be through, the first polarized image light P then goes to the windshield A′, and after the first polarized image light P arrives at the point A11′ of the inner surface A1′ of the windshield A′, thus part of the first polarized image light P is reflected by the windshield A′ to the eyes I of a driver, the driver is only able to see a first virtual image 111′ of the first image source 11′ formed on the windshield A′; and as shown in FIG. 3, which illustrates a schematic view of a second part of the second preferred embodiment of the present invention, a second image source 13′, which is inside the vehicle and is disposed at the top of the windshield A′, the second image source 13′ emits a second polarized image light S having a second polarization s, the polarization of the second polarization s is left hand circular polarization, the second polarized image light S directly goes to or reflects at least one time to the point 1211′ of the light path combining component 12′ after the second polarized image light S is emitted by the second image source 13′, while the light path combining component 12′ is under the mirror mode, the light path combining component 12′ thus reflects the second polarized image light S to the point A11′ of the inner surface A l′ of the windshield A′, and the second polarized image light S is partially reflected by the windshield A′ to the eyes I of the driver, so that the driver only sees a second virtual image 131′ on the windshield A′, a second light path of the second image source 13′ to the eyes I of the driver is longer than a first light path of the first image source 11′ to the eyes I of the driver since the second polarized image light S travels longer distance before hitting on the windshield (A), so that the driver feels that the first virtual image 111′ of the first polarized image light P is closer than the second virtual image 131′ of the second polarized image light S, but the driver cannot see the first virtual image 111′ and the second virtual image 131′ simultaneously for the second preferred embodiment.

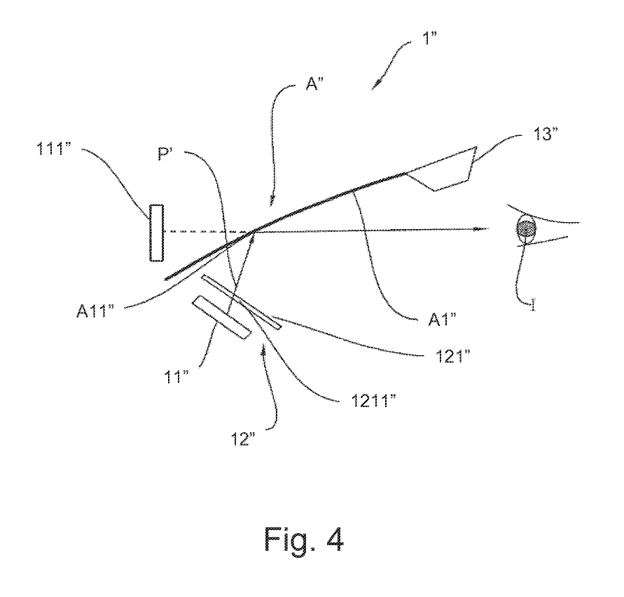

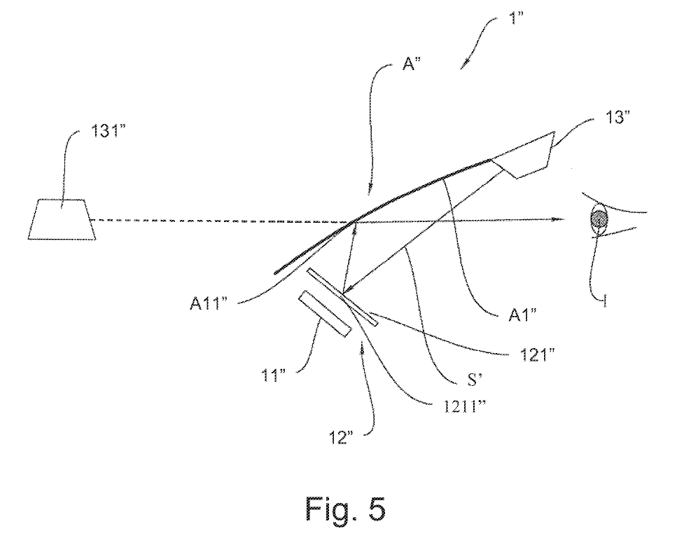

With reference to FIG. 4, which illustrates a schematic view of a first part of a third preferred embodiment of the head-up display device of the present invention. As shown in figure, the head-up display device 1″ that is operated in a vehicle includes: a first movable image source 11″, which is disposed under the windshield A″ of the vehicle, the first movable image source 11″ emits a first image light P′; a shading/non-shading device 12″, which has functions of shading light and letting light be through and is in front of the first movable image source 11″ for that the first image light P′ firstly goes to the shading/non-shading device 12″ after the first image light P′ is emitted by the first movable image source 11″, the shading/non-shading device 12″ is a mechanical device for switching the functions of shading light and letting light be through, while the shading/non-shading device 12″ is under the function of letting light be through, the shading/non-shading device 12″ only lets the first image light P′ be through, the first image light P′ then goes to the windshield A″, and after the first image light P′ arrives at the point A11″ of the inner surface A1″ of the windshield A″, thus part of the first image light P′ is reflected by the windshield A″ to the eyes I of a driver, the driver is only able to see a first virtual image 111″ of the first movable image source 11″ formed on the windshield A″; and as shown in FIG. 5, which illustrates a schematic view of a second part of the third preferred embodiment of the present invention, a second movable image source 13″, which is inside the vehicle and is disposed at the top of the windshield A″, the second movable image source 13″ emits a second image light S′, the second image light S′ directly goes to or reflects at least one time to the point 1211″ of the shading/non-shading device 12″ after the second image light S′ is emitted by the second movable image source 13″, while the shading/non-shading device 12″ is under the function of shading light, the shading/non-shading device 12″ thus reflects the second image light S′ to the point A11′ of the inner surface A1″ of the windshield A″, and the second image light S′ is partially reflected by the windshield A″ to the eyes I of the driver, so that the driver only sees a second virtual image 131″ on the windshield A″, a second light path of the second movable image source 13″ to the eyes I of the driver is longer than a first light path of the first movable image source 11″ to the eyes I of the driver since the second image light S′ travels longer distance before hitting on the windshield (A), so that the driver feels that the first virtual image 111″ of the first image light P′ is closer than the second virtual image 131″ of the second image light S′, but the driver cannot see the first virtual image 111″ and the second virtual image 131″ simultaneously for the third preferred embodiment.

According to aforesaid, the first movable image source 11″ and the second movable image source 13″ are able to move in the vehicle for adjusting focal length.

As a conclusion, the first preferred embodiment focuses on that the driver should see the two images, one is far and the other is near, outside the vehicle simultaneously, hence the first image source 11 and the second image source 13 shall be activated simultaneously; the second preferred embodiment and the third preferred embodiment focus on that the driver should only see one of the two images, one is far and the other is near, outside the vehicle, hence either the first image source 11′ and the first movable image source 11″ or the second image source 13′ and the second movable image source 13″ shall be activated at a time.

Compared to prior arts, the provided by the present invention has the following adventures listed below:
1. Two modes for long-distance and short-distance can be operated together and be applied to specific display or warning purposes. For instance, while driving at night, the long-distance mode displays a moving animal or a static object that cannot not be seen clearly, thus what kind of the moving animal is or what the volume of the static object is can hardly be determined. For the case, if the mode of short-distance is equipped, the detail information for the moving animal or statistic object can be shown to let the driver know how the next step should do. If the moving animal is a rabbit, changing lane or slowing down speed will be an option; if there is a deer, then a stopping procedure shall be started immediately.
2. Depending on road status, the modes of long-distance and short-distance can be selected. For instance, only the short-distance mode satisfies the demands of vehicle in downtown due to slow speed; on the other hand, while vehicle is in an open place and to monitor a long-distance image and a short-distance image is no longer a must, only the long-distance mode should be activated. Therefore, through the long-distance mode, once a moving animal or a statistic object appears, preparations corresponding to the moving animal or the statistic object shall be ready immediately.

Although the invention has been disclosed and illustrated with reference to particular embodiments, the principles involved are susceptible for use in numerous other embodiments that will be apparent to persons skilled in the art. This invention is, therefore, to be limited only as indicated by the scope of the appended claims

What is claimed is:

1. A head-up display device that is operated in a vehicle comprising:
a first image source, which is disposed under the windshield of the vehicle, the first image source emitting a first polarized image light having a first polarization;
a light path combining component, which is in front of the first image source for that the first polarized image light firstly goes to the light path combining component after the first polarized image light is emitted by the first image source, the light path combining component only letting the first polarized image light be through, the first polarized image light then going to the windshield, thus part of the first polarized image light being reflected by the windshield to the eyes of a driver; and
a second image source, which is inside the vehicle, the second image source emitting a second polarized image light having a second polarization, the second polarized image light directly going to or reflecting at least one time to the light path combining component after the second polarized image light is emitted by the second image source, the light path combining component thus reflecting the second polarized image light to the windshield, and the second polarized image light being partially reflected by the windshield to the eyes of the driver, with the first polarized image light going to the eyes of the driver, a second light path of the second image source to the eyes of the driver being longer than a first light path of the first image source to the eyes of the driver since the second polarized image light travels longer distance before hitting on the windshield.

2. The head-up display device according to claim 1, wherein the light path combining component is a reflective polarizer plate.

3. The head-up display device according to claim 1, wherein the polarization of the first polarization of the first polarization image light is orthogonal to the polarization of the second polarization of the second polarization image light.

4. The head-up display device according to claim 1, wherein the polarization of the first polarization of the first polarized image light is right hand circular polarization and the polarization of the second polarization of the second polarized image light is left hand circular polarization.

5. The head-up display device according to claim 1, wherein the polarization of the first polarization of the first polarized image light is left hand circular polarization and the polarization of the second polarization of the second polarized image light is right hand circular polarization.

6. A head-up display device that is operated in a vehicle comprising:
a first image source, which is disposed under the windshield of the vehicle, the first image source emitting a first polarized image light having a first polarization;
a light path combining component, which has a penetration mode and a mirror mode and is in front of the first image source for that the first polarized image light firstly goes to the light path combining component after the first polarized image light is emitted by the first image source, while the light path combining component is under the penetration mode, the light path combining component only letting the first polarized image light be through, the first polarized image light then going to the windshield, thus part of the first polarized image light being reflected by the windshield to the eyes of a driver, the driver being only able to see a first virtual image of the first image source formed on the windshield; and
a second image source, which is inside the vehicle, the second image source emitting a second polarized image light having a second polarization, the second polarized image light directly going to or reflecting at least one time to the light path combining component after the second polarized image light is emitted by the second image source, while the light path combining component is under the mirror mode, the light path combining component thus reflecting the second polarized image light to the windshield, and the second polarized image light being partially reflected by the windshield to the eyes of the driver, a second light path of the second image source to the eyes of the driver being longer than a first light path of the first image source to the eyes of the driver since the second polarized image light travels longer distance before hitting on the windshield, so that the driver feels that the first virtual image of the first polarized image light is closer than a second virtual image of the second polarized image light.

7. The head-up display device according to claim 6, wherein the light path combining component is a switch mirror reflecting component.

8. The head-up display device according to claim 6, wherein the polarization of the first polarization of the first polarized image light is right hand circular polarization.

9. The head-up display device according to claim 6, wherein the polarization of the second polarization of the second polarized image light is left hand circular polarization.

10. A head-up display device that is operated in a vehicle comprising:
a first movable image source, which is disposed under the windshield of the vehicle, the first movable image source emitting a first image light;
a shading/non-shading device, which has functions of shading light and letting light be through and is in front of the first movable image source for that the first image light firstly goes to the shading/non-shading device after the first image light is emitted by the first movable image source, while the shading/non-shading device is under the function of letting light be through, the shading/non-shading device only letting the first image light be through, the first image light then going to the windshield, thus part of the first image light being reflected by the windshield to the eyes of a driver, the driver being only able to see a first virtual image of the first movable image source formed on the windshield; and
a second movable image source, which is inside the vehicle, the second movable image source emitting a second image light, the second image light directly going to or reflecting at least one time to the shading/non-shading device after the second image light is emitted by the second movable image source, while the shading/non-shading device is under the function of shading light, the shading/non-shading device thus reflecting the second image light to the windshield, and the second image light being partially reflected by the windshield to the eyes of the driver, a second light path of the second movable image source to the eyes of the driver being longer than a first light path of the first movable image source to the eyes of the driver since the second image light travels longer distance before hitting on the windshield, so that the driver feels that the first virtual image of the first image light is closer than a second virtual image of the second image light.

11. The head-up display device according to claim 10, wherein the shading/non-shading device is a mechanical device for switching the functions of shading light and letting light be through.
